(19) United States
(12) Patent Application Publication
(10) Pub. No.: US 2025/0050700 A1
(43) Pub. Date: Feb. 13, 2025

(54) SENSOR CONFIGURATIONS FOR LOAD SENSING

(71) Applicant: Sensata Technologies, Inc., Attleboro, MA (US)

(72) Inventors: Jason Neil Kennedy, Kells (GB); Barry Gerard Gray, Belfast (GB); Dennis Bastiaan Kamphuis, Hengelo (NL); Eric Marco Visser, Enschede (NL)

(73) Assignee: Sensata Technologies, Inc., Attleboro, MA (US)

(21) Appl. No.: 18/792,367

(22) Filed: Aug. 1, 2024

Related U.S. Application Data
(60) Provisional application No. 63/531,525, filed on Aug. 8, 2023.

(51) Int. Cl. B60G 17/019; B60G 11/02; B60G 17/02

(52) U.S. Cl. CPC B60G 17/019; B60G 11/02; B60G 17/023; B60G 2202/11; B60G 2204/1162; B60G 2206/428; B60G 2400/051

(57) ABSTRACT

A load monitoring system and techniques estimate a load on a vehicle, such as a trailer, bus, RV, or other vehicle. The system includes a sensor having a main body housing and an alignment feature. The main body housing contacts a first surface of a suspension component and the alignment feature contacts a second surface of the suspension component.

### CROSS-REFERENCE TO RELATED APPLICATIONS

This application claims the benefit of priority of U.S. Provisional Patent Application No. 63/531,525, titled “Sensor Configurations for Load Sensing,” filed Aug. 8, 2023, the entirety of which is hereby incorporated by reference.

### FIELD OF THE TECHNOLOGY

The subject disclosure relates to sensors, and more particularly to sensor systems used for load sensing on suspension systems.

### BACKGROUND OF TECHNOLOGY

Determining a weight of a load in large vehicles, e.g., trailers, recreational vehicles, commercial dump trucks, or the like, may be of interest. For example, the load on a vehicle can impact many aspects of the vehicle, including but not limited to fuel efficiency, component wear, asset monitoring, compliance with regulations, and/or the like. Some existing load monitoring solutions involve complex physical sensor configurations, complex setup routines, and/or complex computing systems.

Accordingly, there is a need in the art for an improved load sensing system that reliably detects and/or quantifies vehicle loads, without expensive, time-consuming, and/or otherwise complex setup and/or operation requirements.

### SUMMARY OF THE TECHNOLOGY

The subject technology relates to improved load monitoring systems and methods of using such systems. For example, aspects of this disclosure relate to improved load sensing systems that determine load on a vehicle, such as on a trailer or other commercial vehicle, using a sensor such as an angle sensor.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a perspective view of aspects of a suspension system including a leaf spring and sensors associated with the leaf spring, in accordance with aspects of this disclosure.

FIG. 2A is a perspective view of one of the sensors illustrated in FIG. 1, in accordance with aspects of this disclosure.

FIG. 2B is a side view of the sensor of FIG. 2A, in accordance with aspects of this disclosure.

FIG. 3A is a perspective view of a portion of the suspension system of FIG. 1, in accordance with aspects of this disclosure.

FIG. 3B is an elevation view of the portion of the suspension system shown in FIG. 3A, in accordance with aspects of this disclosure.

FIG. 4 is a side view of an alternative sensor, in accordance with aspects of this disclosure.

FIG. 5 is a flow diagram showing aspects of load monitoring using arrangements described herein, in accordance with aspects of this disclosure.

### DETAILED DESCRIPTION

The subject technology overcomes many of the prior art problems associated with load monitoring systems. In brief summary, the subject technology provides an improved load monitoring system that minimizes parts, set up times, and/or calibration complexities. In aspects of this disclosure, a sensor, such as an angle sensor, includes incorporated alignment features to ensure easy setup and reliable calibration. For example, the alignment features may ensure that the sensor is properly aligned relative to the vehicle suspension system. Moreover, the alignment feature may also, or alternatively, ensure proper alignment of the sensor relative to other sensors.

Once positioned properly, via the alignment features, the sensor system can be simply and quickly calibrated, thereby simplifying installation and calibration of the sensor and the sensor systems. Once properly aligned and calibrated, data from the sensor may be used to determine the load placed on the trailer/vehicle. Moreover, the alignment features may further maintain the position of the sensor, e.g., during use of the vehicle, such that an accuracy of the system remains in tolerance during use. In examples, the systems and techniques disclosed herein may achieve improved load determination, e.g., with increased accuracy and/or reliability, and in some instances may do so using angle sensors.

Without limitation, the improvements described herein can provide improved load monitoring techniques for use in various applications, including over-the-road applications, as with a tractor-trailer or other large commercial vehicle. However, this disclosure is not limited to use in such applications; the systems and techniques described herein may be useful with any load determining scenarios that can benefit from the improved systems and techniques detailed herein.

As noted above, one application of load monitoring systems like those described herein is for determining a load on a commercial vehicle, such as a trailer, a recreational vehicle, a dump truck, a loader, or the like. Specifically, techniques described herein can associate one or more angle sensors with an elongate, load bearing component, such as a leaf spring, torsion bar, or the like. The angle sensors, when properly oriented and calibrated, can determine angular deflection of the component(s) with which they are associated. Information about this angular deflection can be used to determine load, e.g., by inferring the load from the amount of the deflection, characteristics of the deflecting component(s), characteristics of the vehicle, and/or other factors. Using the angle sensor(s) in this manner may provide a cost-effective way to determine a load on a vehicle, which can be useful to comply with regulations, to prevent over-or under-loading, to infer part wear, and/or the like, as detailed further herein.

These advantages, and other features of the systems and methods disclosed herein, will become more readily apparent to those having ordinary skill in the art from the following detailed description of certain preferred embodiments taken in conjunction with the drawings which set forth representative examples of the present disclosure.

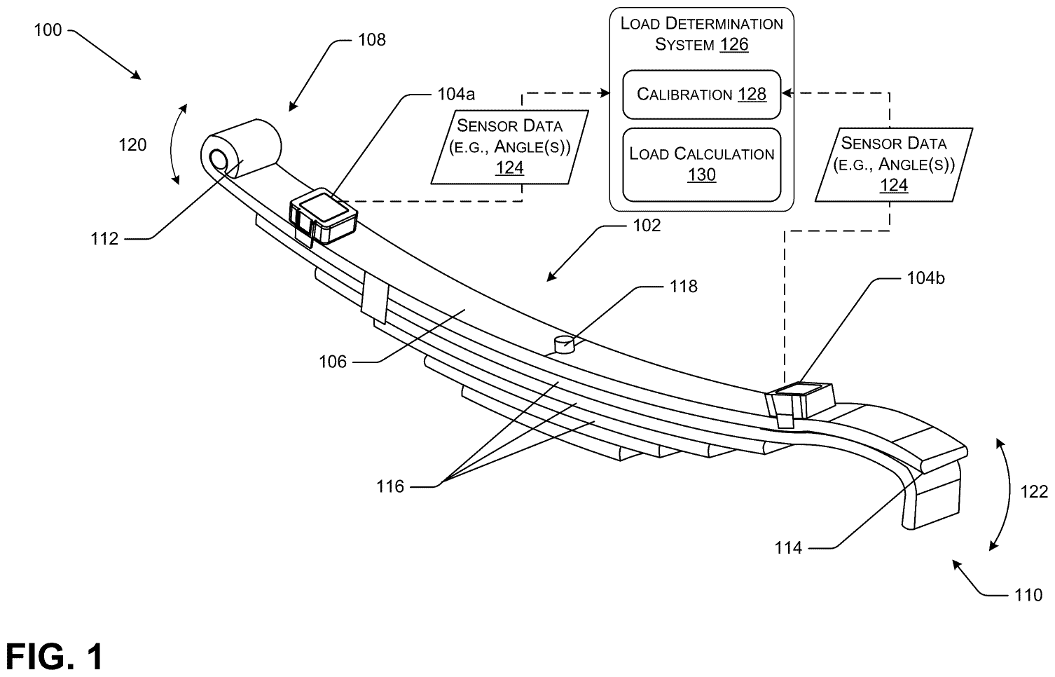

FIG. 1 is a perspective view of aspects of a portion of a vehicle suspension system 100. Specifically, FIG. 1 illustrates a leaf spring 102. FIG. 1 also illustrates a first sensor 104a and a second sensor 104b coupled to the leaf spring 102. The first sensor 104a and the second sensor 104b may be collectively referred to herein as “the sensors 104” and/or individual of the first sensor 104a and the second sensor 104b may be referred to herein as “the sensor 104.”

The leaf spring 102 is illustrated as an example of a component of the vehicle suspension system 100. The leaf spring 102 may be a conventional leaf spring including a main leaf 106 extending generally between a first end 108 and a second, opposite end 110. In the illustrated example, the first end 108 includes an eye mount 112 and the second end 110 includes a slipper mount 114. The leaf spring 102 is also illustrated as including a number of companion or graduated leafs 116 disposed below (in the orientation of FIG. 1) the main leaf 106. The leaf spring 102 shown in FIG. 1 is merely for example. For example, although the leaf spring 102 is illustrated as including five companion leafs 116, more or fewer may be included. Moreover, although the first end 108 is illustrated as including the eye mount 112 and the second end 110 is illustrated as including the slipper mount 114, other arrangements and configurations are contemplated. For instance, either or both of the ends 108, 110 may include the eye mount 112 or the slipper mount 114, and/or some other mounting structure or arrangement.

The leaf spring 102 also is illustrated as including a central bolt 118. Although not illustrated, the central bolt 118 can be coupled to an axle of the vehicle including the leaf spring 102, e.g., via a bracket or other mounting structure. The two ends 108, 110 are configured to couple to a chassis of the vehicle, e.g., at locations spaced from the axle of the vehicle, as is generally conventionally known in the art. During loading of the vehicle, the leaf spring 102 acts to distribute weight along the length of the spring, e.g., between the first end 108 and the second end 110. As the load on the vehicle (and thus on the leaf spring 102) increases and decreases, the leaf spring 102 will flex relatively more or less, e.g., between the ends 108, 110. For example, an arrow 120 in FIG. 1 shows a general direction of flexure of the leaf spring 102 proximate the first end 108, and an arrow 122 in FIG. 1 shows a general direction of flexure of the leaf spring 102 proximate the second end 110.

The sensors 104 are disposed to sense or measure these deflections of the leaf spring 102. For example, and as illustrated, the first sensor 104a is mounted proximate the first end 108 of the leaf spring 102 and the second sensor 104b is mounted proximate the second end 110 of the leaf spring 102. As illustrated, the sensors 104 are disposed on a top surface of the main leaf 106 of the leaf spring 102. In examples of this disclosure, the sensors 104 are angle sensors configured to generate one or more signals, e.g., as sensor data 124, corresponding to the angular displacement of the leaf spring 102. For example, the angular displacement may be an angle generally along the arrow 120 or the arrow 122. Without limitation, the angle sensors 104 may be calibrated or zeroed with the leaf spring 102 in an unloaded state and the measured displacements may be relative to this “normal” position.

As shown in FIG. 1, the sensor data 124 is transmitted to a load determination system 126. For example, the load determination system 126 may comprise a computing system, such as a computing system in the vehicle of which the leaf spring 102 is a part, a remote computing system, e.g., on a remote computing device such as a mobile device, or some other computing system. The sensor data 124 generated by the sensors 104 may be transmitted to the load determination system 126 wirelessly and/or via a wired connection (including but not limited to a CAN bus or the like). In examples, the sensor data 124 can be transmitted to the load determination system 126 periodically, e.g., at a predetermined frequency, on demand, and/or otherwise. Moreover, although not illustrated, the load determination system 126 may be configured to send information to the sensors 104, e.g., to instruct the sensors 104 to transmit the sensor data 124.

The load determination system 126 is illustrated as including a calibration component 128 and a load calculation component 130. For example, the calibration component 128 and/or the load calculation component 130 may be embodied as software, hardware, firmware, and/or the like. Although shown as different components for the ease of illustration and explanation, in examples the functionality of the calibration component 128 and the load calculation component 130 may be embodied in the same component, memory, software, and/or the like.

The calibration component 128 generally includes functionality to calibrate the sensors 104. For example, and as detailed further herein, the sensors 104 can be aligned on the leaf spring 102, via one or more alignment features detailed further herein. The alignment features generally dispose the sensors 104 in a predetermined orientation, e.g., relative to the leaf spring 102 and/or relative to each other. Accordingly, the calibration component 128 can implement relatively simplified processes. For example, and without limitation, the calibration component 128 can determine a normal or at rest orientation (e.g., angle) of the sensors 104, e.g., with no (additional) loading on the vehicle.

The load calculation component 130 generally includes functionality to determine a load on the vehicle, e.g., based on the sensor data 124. In some examples, the load calculation component 130 can include or otherwise access a lookup table or the like that correlates an output of the sensors 104, e.g., a measured angle, to a vehicle load. For example, the load calculation component 130 can infer a load on the vehicle based on an angular displacement determined from the sensor data 124 associated with one or both of the first sensor 104a and/or the second sensor 104b. In examples, the load determined by the load calculation component 130 can be transmitted to a user, e.g., an operator of the vehicle, a fleet manager, a telemetric system, and/or the like. In examples, the calculated load may be displayed on a display screen associated with a device in the vehicle, a mobile device, or the like.

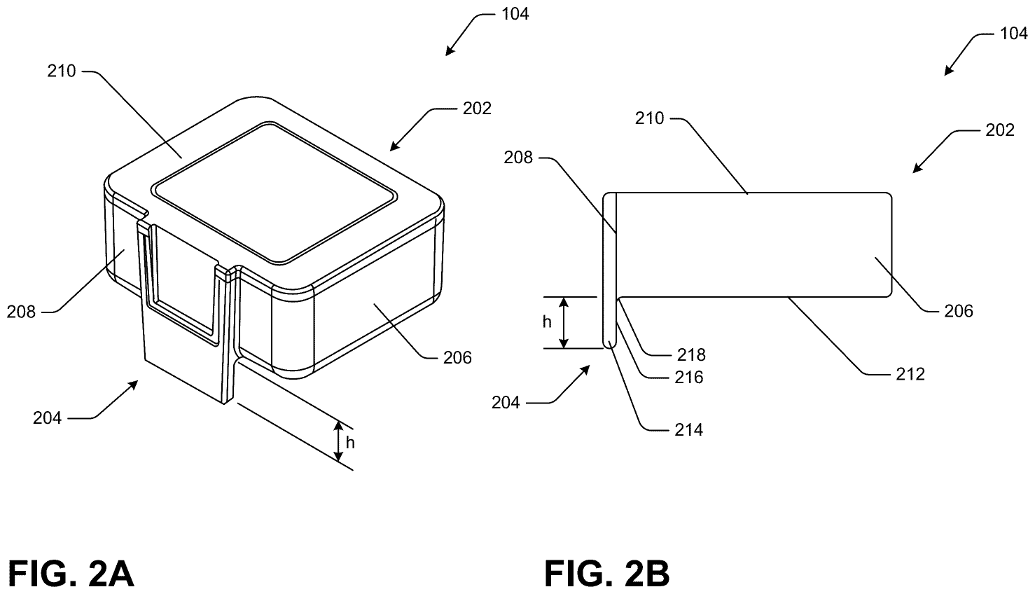

FIGS. 2A and 2B show aspects of the sensor 104 (e.g., which may be the first sensor 104a or the second sensor 104b) in more detail. More specifically, FIGS. 2A and 2B show that the sensor 104 includes a main housing 202 and an alignment feature 204. The main housing 202 is sized and shaped to contain, support, and/or otherwise house functioning components of the sensor 104. For example, the main housing 202 may be structured to position the functional components of the sensor 104 in a predetermined orientation, e.g., relative to the main housing 202 and/or the alignment feature 204.

In more detail, FIGS. 2A and 2B show that the main housing 202 includes a first lateral sidewall 206 and a first longitudinal sidewall 208. Obscured in FIGS. 2A and 2B, the main housing 202 also includes a second lateral sidewall, opposing the first lateral sidewall 206, and a second longitudinal sidewall opposing the first longitudinal sidewall 208. The sidewalls 206, 208 extend, e.g., in an elevational direction, between a top surface 210 and a bottom surface 212. Thus, in the illustrated example, the main housing 202 is shaped as a rectangular prism. However, the main housing 202 is not limited to the illustrated configuration; other shapes, sizes, and/or the like may be used. Without limitation, the main housing 202 may be cylindrical in shape, cubic and/or have any other shape or configuration. As will be appreciated, although the main housing 202 is illustrated as a contiguous structure, in examples, the main housing 202 may be made from two or more components that are fit and secured together, e.g., to retain the functional components of the sensor 104 therein. The main housing 202 may be an enclosure containing functional components, such as an angle sensor or the like.

The alignment feature 204 includes a protruding leg 214 that extends below the bottom surface of the main housing 202, generally at the longitudinal sidewall 208. In the example, the protruding leg extends a distance, h, below the bottom surface 212 of the main housing 202. The alignment feature 204 may be formed integrally with a portion of the main housing 202. Without limitation, at least a portion of the main housing 202 can be molded, e.g., injection molded, to include the alignment feature 204. In other examples, the alignment feature 204 can be a separate component secured to the main housing 202, e.g., using one or more fasteners, adhesives, and/or the like.

The protruding leg 214 defines an inner surface 216. As illustrated, the inner surface 216 is arranged generally perpendicular to the bottom surface 212. A radius 218 may be formed at an intersection of the inner surface 216 and the bottom surface 212. The functional components of the sensor 104, which are disposed at least partially in the main housing 202, may be oriented relative to the inner surface 216. For example, aspects of the functional components of the sensor 104 may be disposed a predetermined distance from the inner surface 216. For example, and without limitation, an interior volume defined by the main housing 202 may include one or more alignment and/or mounting features (not shown) for aligning and/or constraining movement of the functional components of the sensor 104. In some examples, the functional components of the sensor 104 may be disposed to measure angular changes in a plane parallel to (or coplanar with) the inner surface 216. Of course, this orientation of the sensing component is for example only; other arrangements are contemplated.

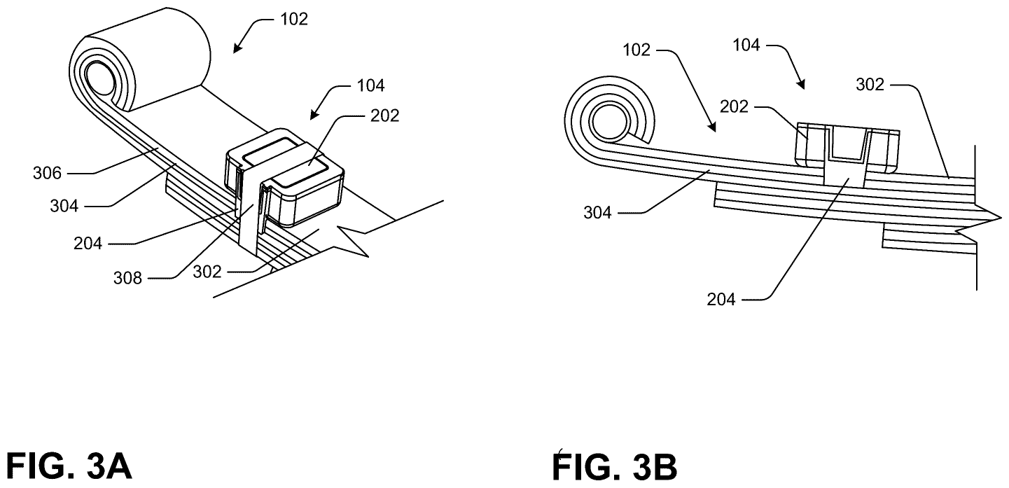

As best illustrated in FIGS. 3A and 3B, the alignment feature 204 orients the sensors 104 on the leaf spring 102. Specifically, the sensor 104 is mounted on the leaf spring 102 such that the bottom surface 212 of the main housing 202 rests on a top surface 302 of the main leaf 106, and the inner surface 216 of the alignment feature 204 abuts an edge 304 of the main leaf 106 of the leaf spring 102. Thus, the bottom surface 212 of the main housing 202 may be a first contact surface and the inner surface 216 of the alignment feature 204 may be a second contact surface. In operation, as discussed herein, the two contact surfaces will limit degrees of freedom of the sensor 104, thereby limiting relative movement of the sensor 104 and the leaf spring 102.

As noted above, an intersection of the inner surface 216 of the alignment feature 204 and the bottom surface 212 of the main housing 202 forms the radius 218. In the example of FIGS. 3A and 3B, the leaf spring 106 has a radiused edge 306 at an intersection of the top surface 302 of the main leaf 106 and the edge 304 of the main leaf 106. In the example, the radiused edge 306 has a larger radius than the radius 218 on the sensor 104. Accordingly, the bottom surface 212 of the main housing 202 can mount flush with the top surface 302 of the main leaf 106 and the inner surface 216 of the alignment feature 204 is flush with the edge 304 of the main leaf 106. In other examples, the radius 218 may be replaced with an undercut. Thus, the main sensor 104 contacts the leaf spring 102 at two regions, arranged normal to each other, e.g., to constrain two degrees of motion. Thus, for example, the alignment feature 204 prevents the sensor from rotating or spinning on the top surface 302 of the main leaf 106 of the leaf spring 102.

As illustrated in hidden lines in FIG. 3A, a strap 308 may be used to secure the sensor 104 relative to the leaf spring 102. Although a strap 308 is illustrated, in other examples the sensor 104 may be otherwise secured to the leaf spring 102. For example, the sensor 104 may be secured to the leaf spring 102 using a belt, an adhesive, or some other fastener. Without limitation, the fastener may be any structure, apparatus, or other means that can secure the sensor 104, e.g., to ensure that the sensor 104 does not move relative to the leaf spring 102 once properly aligned. The fastener may retain the bottom surface 212 of the main housing 202 at a fixed position relative to the top surface 302, e.g., abutting the top surface 302. The fastener may also retain the inner surface 216 of the alignment feature 204 at a fixed position relative to the edge 304, e.g., abutting the edge 304.

As illustrated in FIG. 1, the first sensor 104a and the second sensor 104b are both provided on the leaf spring 102. Sensor data from both may be used to determine a displacement (and thus an associated load). In examples, the first sensor 104a and the second sensor 104b are substantially identical, e.g., such that when both of the sensors 104a, 104b are secured to the same edge 304 of the leaf spring 102, the sensors 104 are substantially coplanar with each other, e.g., in a plane parallel to the edge 304. In this manner, the sensors may be disposed to measure angular displacements in a same plane. For example, first sensor data from the first sensor 104a and second sensor data from the second sensor 104b may be combined, e.g., to determine an overall deflection of the leaf spring 102. In other examples, the first sensor data may be used to determine a first estimated load and the second sensor data may be used to determine a second estimated load. In examples, an overall estimated load can be based on both the first and second estimated loads. For instance, the overall estimated load may be an average of the two valuations associated with the first and second estimated loads. In other examples, first estimated load may be used when the first estimated load and the second estimated load are within a threshold difference. In other examples, only one sensor 104 may be provided on the leaf spring 102 and/or when two sensors are provided, as in the example of FIG. 1, sensor data from only one may be used to determine the estimated load. For example, the second sensor may be for redundancy or the like.

Modifications to the foregoing aspects also are contemplated. For example, while the alignment feature 204 is illustrated as a leg 214 extending from the main body of the 202, in other examples the alignment feature may be otherwise formed. For instance, the leg 214 may be replaced with one or more posts or other protruding feature(s). Without limitation, any feature that provides a point or surface that can contact the edge 304 of the leaf spring 102 may be used as the alignment feature 204. In examples, any alignment feature that is coupled to the sensor body and aligns the sensor 104 with a portion of the suspension system and/or with another sensor may be used.

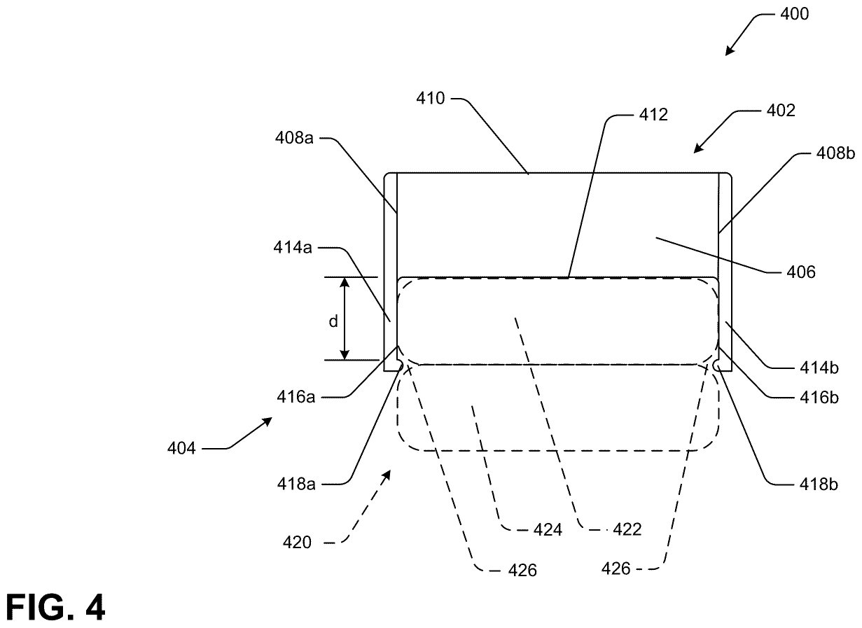

FIG. 4 shows aspects of another example of a sensor 400, which may be the first sensor 104a or the second sensor 104b) in more detail. More specifically, FIG. 4 shows that the sensor 400, like the sensor 104 discussed above, includes a main housing 402 and an alignment feature 404. The main housing 402 is sized and shaped to contain, support, and/or otherwise house functioning components of the sensor 400. For example, the main housing 402 may be structured to position the functional components of the sensor 400 in a predetermined orientation, e.g., relative to the main housing 402 and/or the alignment feature 404.

Like the main housing 202 discussed above, the main housing 402 includes a first lateral sidewall 406 (and an opposing lateral sidewall not seen in FIG. 4) and first and second longitudinal sidewalls 408a, 408b. The sidewalls 406, 408a, 408b extend, e.g., in an elevational direction, between a top surface 410 and a bottom surface 412. Thus, in the illustrated example, as in the example of FIGS. 2A and 2B, the main housing 402 is shaped as a rectangular prism. As noted above, the main housing 402 may be an enclosure containing functional components, such as an angle sensor or the like.

The alignment feature 404 includes a first protruding leg 414a and a second protruding leg 414b. The first protruding leg 414a extends below the bottom surface 412 of the main housing 402, generally at the first longitudinal sidewall 408a, and the second protruding leg 414b extends below the bottom surface 412 of the main housing 402, generally at the second longitudinal sidewall 408b. In the example, the protruding legs 414a, 414b extend a distance, below the bottom surface 412 of the main housing 402. The alignment feature 404 may be formed integrally with a portion of the main housing 402. Without limitation, at least a portion of the main housing 402 can be molded, e.g., injection molded, to include the alignment feature 404. In other examples, the alignment feature 404 can be a separate component secured to the main housing 202, e.g., using one or more fasteners, adhesives, and/or the like.

The first protruding leg 414a defines a first inner surface 416a, and the second protruding leg 414b defines a second inner surface 416b. As illustrated, the inner surfaces 416a, 416b are arranged generally parallel to each other, and perpendicular to the bottom surface 412. Functional components of the sensor 400, which are disposed at least partially in the main housing 402, may be oriented relative to the inner surfaces 416a, 416b. For example, aspects of the functional components of the sensor 400 may be disposed a predetermined distance from one or both of the inner surface 416a, 416b. In some examples, the functional components of the sensor 400 may be disposed to measure angular changes in a plane parallel to (or coplanar with) the inner surfaces 416a, 416b.

As also illustrated in FIG. 4, the first inner surface 416a is spaced from the second inner surface 416b by a width. In examples of this disclosure the width may be determined based at least in part on a width associated with a leaf spring, such as the leaf spring 102. For example, the width may correspond to a width of the main leaf 106. In examples, the sensor 400 may be coupled to the leaf spring 102, such that the first inner surface 416a contacts a first edge, e.g., the edge 304, of the leaf spring 102, and the second inner surface 416b contacts a second edge, e.g., an edge opposing the edge 304.

FIG. 4 also shows that the first protruding leg 414a can include a first protrusion 418a and the second protruding leg 414b can include a second protrusion 418b. As illustrated, the protrusions 418a, 418b protrude from the respective inner surfaces 416a, 416b in a direction toward each other. Thus, the protrusions 418a, 418b effectively reduce the width between the inner surfaces 416a, 416b. In examples, the protrusions 418a, 418b may be spaced from the bottom surface 412 a distance, d. The distance, d, may correspond generally to a thickness of a leaf on which the sensor 400 is to be mounted. For example, the distance, d, may generally correspond to a thickness of the main leaf 106 of the leaf spring 102.

FIG. 4 includes, in hidden lines, an example of a portion of a leaf spring 420, generally including a main leaf 422 and a secondary leaf 424. Although only a single instance of the secondary leaf 424 is illustrated, the leaf spring 420 can include more than one secondary leaf 424. As illustrated, the sensor 400 is positioned on the leaf spring 420 such that the inner surfaces 416a, 416b contact opposed edges of the main leaf 422 and the protrusions 418 extend into gaps 426 formed between the main leaf 422 and the adjacent secondary leaf 424. In examples, the protruding legs 414a, 414b can flex, e.g., away from each other, as the sensor 400 is placed onto the leaf spring 420, and the legs 414a, 414b will then return to the normal position shown when the protrusions 418a, 418b are disposed in the gaps 426. Thus, the protrusions 418a, 418b may allow for the sensor 400 to be “snapped” onto the leaf spring 420, which may obviate the need for additional fasteners and/or attachment schemes.

In some examples of this disclosure, the protrusions 418a, 418b may not be used. Moreover, although illustrated in connection with the sensor 400, the sensor 104 may include one of the protrusions 418a, 418b. For example, the alignment feature 204 may include a protrusion proximate a distal end of the inner surface 216.

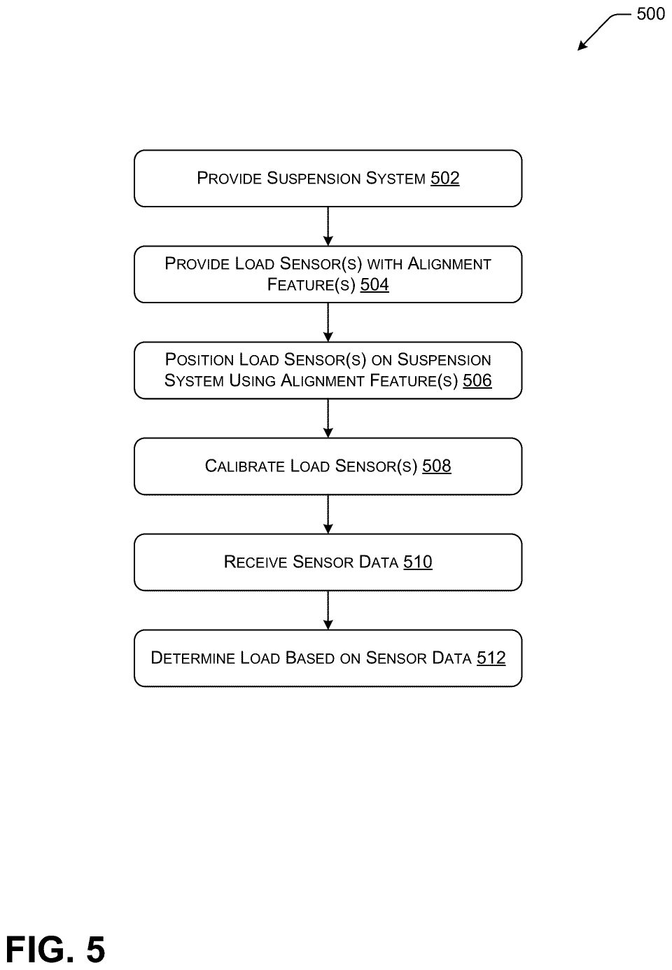

FIG. 5 is a flow chart representing a process 500 for determining a load on a suspension system in association with aspects of this disclosure.

At an operation 502, the process 500 includes providing a suspension system. For example, the operation 502 can include providing a leaf spring, like the leaf spring 102 or the leaf spring 420 as a portion of a suspension on a vehicle or the like. In other instances, the suspension system can include a torsion rod, or the like.

At an operation 504, the process 500 includes providing one or more load sensors with alignment features. As noted above, the alignment feature 204, 404 may be provided as one or more surfaces 216, 416 extending below the bottom surface 212, 412. Other alignment features also are contemplated herein. For example, the load sensors may be angle sensors.

At an operation 506, the process 500 includes positioning the one or more load sensors on the suspension system using the alignment feature(s). For example, and as discussed above, one or more surfaces of the main housing 202 402 of the sensor 104, 400 may be positioned to abut a first surface of the suspension system component, and a surface of the alignment feature may be positioned to abut one or more additional, different surfaces of the suspension system. Thus, the surface of the main body of the housing and the alignment feature provide at least two areas of contact to align the sensor 104, 400 in a predetermined (and desired) orientation. Moreover, in the example of FIG. 4, the protrusions 418 may facilitate coupling of the sensor 400 to the leaf spring 420.

At an operation 508, the process 500 can include calibrating the load sensor(s). For example, the calibration component 128 can determine initial sensor output(s) associated with one or more instances of the sensors 104, 400, e.g., with the vehicle unloaded. As noted above, because the sensor(s) are aligned within a predetermined threshold, the operation 508 can be greatly simplified relative to other conventional sensor calibration techniques and/or schemes. For example, when the sensors are affixed to the leaf springs, but are not properly aligned or oriented, a complex calibration procedure may be required. This complex procedure can include physically tilting the vehicle/trailer to which the sensor(s) 104, 400 is coupled in a specified axis, followed by complex computation, such as using an Euler transformation to determine “rotation matrix” for each sensor. The rotation matrix may then be applied to all subsequent measurements used to mathematically align each sensor with the suspension system and with other sensors. By introducing the alignment feature, calibration requirements may be significantly reduced, e.g., because the sensors are already aligned within some predetermined tolerance. Moreover, when additional straps, adhesives, belts, and/or the like are used to secure the sensor 104, the alignment feature ensures the correct orientation of the sensor relative to the suspension without complex machinery, measurement tools, and/or the like. Stated differently, physical installation of the sensor 104 is greatly simplified by virtue of the alignment feature.

At an operation 510, the process 500 can include receiving sensor data, e.g., from the load sensor(s). The sensor data may include one or more signals associated with an angle or an angular displacement of the leaf spring 102, 420, as described above. For instance, the sensor(s) can transmit, publish, or otherwise provide the sensor data at a predetermined frequency, on demand, or otherwise.

At an operation 512, the process 500 can include determining a load based on the sensor data. For example, the load calculation component 130 can calculate, infer, or otherwise determine an estimated load based on the senor data received at the operation 510. Examples of determining a load from sensor data are disclosed in co-owned PCT Application No. PCT/US21/43749, titled “Vehicular Load Sensing System and Method Using Tilt Sensors,” the entire disclosure of which is hereby incorporated by reference. In one non-limiting example, the estimated load may be correlated to a load on the vehicle. The load calculation component may determine the correlation, e.g., from a look up table or otherwise, and determine the load from the correlation.

As described, the systems described herein provide improved load calculating systems and techniques. In examples, relatively inexpensive components can provide accurate alignment of sensors to more confidently infer load data based on data from the sensor(s).

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A load monitoring system comprising:
a suspension component; and
a sensor coupled to the suspension component, the sensor comprising:
a sensor main body carrying one or more functional sensing components; and
an alignment feature extending from the sensor main body,
wherein the sensor is disposed relative to the suspension component such that a surface of the sensor main body contacts a first surface of the suspension component, and a surface of the alignment feature contacts a second surface of the suspension component different from the first surface.

2. The load monitoring system of claim 1, wherein the sensor is an angle sensor.

3. The load monitoring system of claim 1, wherein:
the suspension component comprises a leaf spring including a main leaf.

4. The load monitoring system of claim 3, wherein:
the surface of the sensor main body comprises a bottom surface of the sensor main body and the bottom surface abuts a top surface of the main leaf; and
the surface of the alignment feature comprises an inner surface of the alignment feature and the inner surface contacts an edge of the main leaf.

5. The load monitoring system of claim 4, wherein the inner surface of the alignment feature is substantially perpendicular to the bottom surface of the sensor main body.

6. The load monitoring system of claim 1, wherein the alignment feature comprises a protruding leg extending from a bottom of the sensor main body.

7. The load monitoring system of claim 6, wherein the alignment feature further comprises a protrusion extending from a surface of the protruding leg at a position spaced from the bottom of the sensor main body.

8. The load monitoring system of claim 1, wherein:
the alignment feature comprises a first protruding leg extending from a bottom of the sensor main body proximate a first side of the sensor main body and a second protruding leg extending from the bottom of the sensor main body proximate a second side of the sensor main body;
the first protruding leg defines a first contact surface; and
the second protruding leg defines a second contact surface substantially parallel to the first contacting surface.

9. The load monitoring system of claim 1, further comprising a fastener coupling the sensor to the suspension component.

10. An angle sensor comprising:
a sensor main body carrying one or more functional sensing components; and
an alignment feature extending from the sensor main body,
wherein the sensor main body defines a first contact surface configured to contact a first surface of a suspension component and the alignment feature defines a second contact surface configured to contact a second surface of the suspension component.

11. The angle sensor of claim 10, wherein:
the alignment feature comprises a leg extending from a bottom surface of the sensor main body proximate a first side of the sensor main body; and
the second contact surface comprises a surface of the leg.

12. The angle sensor of claim 11, wherein:
the first contact surface comprises the bottom surface of the sensor main body; and
the second contact surface is substantially perpendicular to the bottom surface.

13. The angle sensor of claim 11, wherein the alignment feature further comprises a protrusion extending from the surface of the leg.

14. The angle sensor of claim 10, wherein:
the alignment feature comprises a first protruding leg extending from a bottom of the sensor main body proximate a first side of the sensor main body and a second protruding leg extending from the bottom of the sensor main body proximate a second side of the sensor main body;
the first protruding leg defines a first contact surface; and
the second protruding leg defines a second contact surface substantially parallel to the first contacting surface.

15. The angle sensor of claim 14, wherein the first contact surface is spaced from the second contact surface by a distance corresponding to a width of the suspension component.

16. The angle sensor of claim 14, wherein the alignment feature further comprises:
a first protrusion extending from the first contact surface in a direction toward the second contact surface; and
a second protrusion extending form the second contact surface in a direction toward the first contact surface.

17. A method comprising:
providing a sensor comprising a sensor main body carrying one or more functional sensing components and an alignment feature extending from the sensor main body; and
positioning the sensor on a suspension component such that a first contact surface of the sensor main body contacts a first surface of the suspension component and a second contact surface of the alignment feature contacts a second surface of the suspension component.

18. The method of claim 17, further comprising calibrating the sensor.

19. The method of claim 17, further comprising:
receiving sensor data from the sensor; and
determining a load on the suspension component based on the sensor data.

20. The method of claim 17. wherein the suspension component comprises a leaf spring.
